(19) United States
(12) Patent Application Publication
(10) Pub. No.: US 2006/0210611 A1
(43) Pub. Date: Sep. 21, 2006

(54) Fat soluble vitamin feed supplements and processes for delivering same

(76) Inventors: Irmgard Immig, Habsburg (CH); Ross Wilkie, Harriston (CA); Jonathan W. Wilson, Ringwood, NJ (US)

Correspondence Address: NIXON & VANDERHYE, PC, 901 NORTH GLEBE ROAD, 11TH FLOOR, ARLINGTON, VA, 22203, US

(21) Appl. No.: 10/549,147

(22) PCT Filed: Mar. 11, 2004
(86) PCT No.: PCT/EP04/02514

§ 371 Date: May 24, 2006

Related U.S. Application Data
(60) Provisional application No. 60/455,265, filed on Mar. 17, 2003.

(51) Int. Cl. A23K 1/165

(52) U.S. Cl. 424/442; 426/635

(57) ABSTRACT

A process is disclosed for delivering a stable, fat soluble vitamin to a feed composition. The process includes dissolving a fat soluble vitamin in a solvent to form a vitamin-enriched solvent and combining the vitamin-enriched feeds; processes for supplementing the diet of a feed animal with a fat soluble vitamin, processes for extending the shelf life of an animal product, and processes for making stable vitamin-enriched supplements for feed compositions are also provided.

### FIELD OF THE INVENTION

The present invention relates to compositions and processes for providing stable, fat soluble vitamins in various forms.

### BACKGROUND OF THE INVENTION

In large scale feed lots, animal health is regulated, in the first instance, through the composition of the feed provided to the animals. Through feed supplements, the animals are provided with vitamins, minerals, antibiotics, etc. necessary to maintain health and to promote growth prior to harvesting.

Vitamins that are soluble in fat have a nutritional value. (Goodman et al., 1993. Fat-Soluble Vitamins, The Pharmacological Basis of Therapeutics, 8 ed., pg. 1553). For example, consuming a diet with adequate levels of vitamins A, D, E, and K promotes, among other things, metabolism, circulation, and vision.

Animal feeds are also supplemented to enhance the physical appearance of meat to a consumer. For example, color is an important criterion used by consumers to judge the freshness and wholesomeness of meat. (Faustman, C. and Cassens, R. G., 1990. The biological basis for discoloration in fresh meat: a review. J. Muscle Foods. 1:217 and Kropf, D. H. et al., 1985. Color formation and retention in fresh meat. Proc. Meat Ind. Res. Conf American Meat Institute, p. 62, Washington D.C.). For beef, the preferred color is bright cherry-red. (Hood, D. E. and Riordan, E. D. 1973. Discoloration on pre-packaged beef measurement by reflectance spectrophotometry and shopper discrimination. J. Food Technol. 8:333). Quality deterioration in meat occurs when muscle pigment oxidation occurs to a degree that the meat's color is negatively impacted.

In beef for example, myoglobin is the primary pigment responsible for meat color. When exposed to oxygen for the first time, the meat color changes from a purplish-red to a bright red after about thirty minutes, a process called “blooming.” The brown color observed in older beef is generated through the oxidation of the iron in the heme moiety of myoglobin whereby oxymyoglobin is converted to met-myoglobin. (Smith, G. C. et al., 1995. Vitamin E and meat quality. Proc. Victam International Symposium From Feed to Food (Utrecht, The Netherlands) pp. 105-115 and Smith, G. C. et al., 1996. Supplemental Vitamin E in beef cattle diets to improve shelf life of beef. Animal Feed Science Technology. 59:207-214).

Vitamin E, as a fat soluble vitamin, functions as an antioxidant in cell membranes. α-tocopherol, a form of vitamin E, satiates free radicals and protects meat-color pigments, membrane-bound phospholipids, and cholesterol from oxidation. Thus, by increasing the levels of vitamin E in animal meat, such as beef, the attractive red color of the meat is maintained for a longer period of time, which prolongs the shelf life of the meat. (See, e.g., “HIGH E BEEF: THE SCIENCE AND TECHNOLOGY,” G. C. Smith, et al. Presented at the Canadian Beef Summit in Las Vegas, Nev., Feb. 11, 2000).

Most commercially grown animals cannot synthesize vitamin E and normally obtain it by consuming pasture. When animals are moved to a feedlot, they are usually placed on an extended grain feeding regimen. (See e.g. Scott et al., U.S. Pat. No. 6,322,827). Grains, however, are relatively low in vitamin E. Thus, vitamin E may be used to supplement the grain-based feed.

Animal feeds are typically supplemented with vitamins by simply dispersing the supplement over the feed, a process called “top-dressing.” (D. M. Wulf, et al. 1995. Effects of Dietary Vitamin E on Lamb Cuts, J. Anim. Sci. 73:399-405). Such a process, however, is disadvantageous because it is difficult to ensure even distribution of the supplement in the feed. Moreover, each supplement that must be added to an animal feed increases costs, decreases efficiency, and complicates the feeding process.

Alternatively, vitamin supplements are added to the feed during the pelleting process. (See e.g., Remmereit, U.S. Pat. No. 6,344,230 (“Remmereit '230)). For example, Remmereit '230 discloses a conjugated linoleic acid (“CLA”) for use in animal bulk feed. In a preferred embodiment, Remmereit '230 discloses incorporating the CLA into a pelleted feed. Such a method of supplementing feed is also disadvantageous because the supplements are exposed to extreme conditions during the pelleting process, e.g., pressure and heat, which cause a decrease in the activity of the supplement.

Remmereit '230 also recognizes that certain oils used in the process are unstable and suggested that adding an antioxidant, such as a tocopherol, could help to stabilize the oil.

Accordingly, a need exists for a process for supplementing an animal feed with a fat soluble vitamin that is easy to carry out, ensures even distribution, and is economical. A further need exists for a fat soluble vitamin that is stable.

### SUMMARY OF THE INVENTION

These and other needs are achieved by carrying out the invention disclosed and claimed herein.

One embodiment of the present invention is a process for delivering a stable, fat soluble vitamin to a feed composition. This process comprises dissolving a fat soluble vitamin in a solvent selected from the group consisting of a fat source, an oil source, a fatty acid source and combinations thereof to form a vitamin-enriched solvent; and combining the vitamin-enriched solvent with a feed composition.

Another embodiment of the invention is a stable feed premix. The premix comprises a fat soluble vitamin, a solvent selected from the group consisting of a fat source, an oil source, a fatty acid source and combinations thereof, which solvent is capable of dissolving the fat soluble vitamin and delivering to a feed animal about 10 to about 400,000 IU vitamin/day of a vitamin selected from the group consisting of vitamins A, D, and E, or about 0.25-1.0 gm/day of vitamin K, or mixtures of vitamins A, D, E, and K in the amounts provided, and an edible carrier.

A further embodiment of the invention is a stable, vitamin-enriched solvent for supplementing a feed composition. The vitamin-enriched fat source comprises a fat soluble vitamin dissolved in a solvent selected from the group consisting of a fat source, an oil source, a fatty acid source and combinations thereof, which fat soluble vitamin is present in the solvent at a concentration sufficient to deliver to a feed animal about 10 to about 400,000 IU vitamin/day of a vitamin selected from the group consisting of vitamins A, D, and E, or 0.25-1.0 gm/day of vitamin K, or mixtures of vitamins A, D, E, and K in the amounts provided.

Another embodiment of the invention is a stable, vitamin-enriched feed. The vitamin-enriched feed comprises an animal feed composition and a vitamin-enriched solvent comprising a fat soluble vitamin dissolved in a solvent selected from the group consisting of a fat source, an oil source, a fatty acid source and combinations thereof, which fat soluble vitamin is present in the solvent at a concentration sufficient to deliver to a feed animal about 10 to about 400,000 IU vitamin/day of a vitamin selected from the group consisting of vitamins A, D, and E, or about 0.25-1.0 gm/day of vitamin K, or mixtures of vitamins A, D, E, and K in the amounts provided.

A further embodiment of the invention is a process for supplementing the diet of a feed animal with a fat soluble vitamin. This process comprises contacting an animal feed with a vitamin-enriched solvent comprising a fat soluble vitamin dissolved in a solvent selected from the group consisting of a fat source, an oil source, a fatty acid source and combinations thereof, which fat soluble vitamin is present in the solvent at a concentration sufficient to deliver to a feed animal about 10 to about 400,000 IU vitamin/day of a vitamin selected from the group consisting of vitamins A, D, and E, or about 0.25-1.0 gm/day of vitamin K, or mixtures of vitamins A, D, E, and K in the amounts provided.

Another embodiment of the invention is a process for extending the shelf life of an animal product. This process comprises contacting an animal feed with a stable, vitamin-enriched solvent comprising a fat soluble vitamin dissolved in a solvent selected from the group consisting of a fat source, an oil source, a fatty acid source and combinations thereof, which fat soluble vitamin is present in the solvent at a concentration sufficient to deliver to a feed animal about 10 to about 400,000 IU vitamin/day of a vitamin selected from the group consisting of vitamins A, D, and E, or about 0.25-1.0 gm/day of vitamin K, or mixtures of vitamins A, D, E, and K in the amounts provided, to provide an enriched feed; and providing the enriched feed to a feed animal for a sufficient period of time to yield at least 2 μg vitamin/gm animal product when harvested.

Another embodiment of the invention is a process for making a stable vitamin-enriched supplement for a feed composition. This process comprises incorporating a sufficient quantity of a fat soluble vitamin into a solvent selected from the group consisting of a fat source, an oil source, a fatty acid source and combinations thereof to produce a vitamin-enriched supplement that delivers to a feed animal between about 10 to about 400,000 IU vitamin/day of a vitamin selected from the group consisting of vitamins A, D, and E, or about 0.25-1.0 gm/day of vitamin K, or mixtures of vitamins A, D, E, and K in the amounts provided, the fat soluble vitamin being evenly distributed throughout the solvent.

### BRIEF DESCRIPTION OF THE DRAWING

The invention is illustrated and described with reference to the drawing. In the drawing,

FIG. 1 shows the Alpha Tocopherol Concentration over a 125-day period according to McClure et al., 2001,

FIG. 2 shows the a graph representing the vitamin retention in tallow stored at 37° C. according to example 1, and

FIG. 3 to 6 show the statistical analyses according to example 3.

### DETAILED DESCRIPTION

One embodiment of the invention is a process for delivering a stable, fat soluble vitamin to a feed composition. This process includes dissolving a fat soluble vitamin in a solvent to form a vitamin-enriched solvent and combining the vitamin-enriched solvent with a feed composition.

For purposes of the present invention, the term “solvent” means a fat source, an oil source, a fatty acid source and combinations thereof.

As used herein, a “vitamin” is any organic compound essential for normal metabolism, growth, development, and regulation of cell function. A “fat soluble vitamin” is a subset of vitamins that are soluble in a solvent as defined above. Vitamins A, D, E, and K are examples of fat soluble vitamins. As used herein, “fat soluble vitamin” is to be broadly construed to include not only vitamins soluble in a solvent as defined above, but also vitamin precursors, i.e., compounds converted in vivo into a fat soluble vitamin, vitamin metabolites that are also soluble in a solvent, and salts of such compounds. Collectively, the vitamins, vitamin precursors, and vitamin metabolites that are soluble in a solvent as defined above are referred to herein as “fat soluble vitamins.” In the present invention, combinations of the fat soluble vitamins may be dissolved in the solvent. Preferably, the fat soluble vitamin is vitamin E and salts thereof.

The “fat soluble vitamin” of the present invention may be used in any convenient form so long as it is capable of dissolving in a solvent. Thus, the fat soluble vitamin may be in the form of, for example, powders, flakes, liquids, oils, dispersions, such as colloidal dispersions, or emulsions. Preferably, the fat soluble vitamin is in the form of an oil, such as a vitamin E oil. More preferably, the vitamin E (as d,1-α-tocopherol) is in the form of a dispersible liquid concentrate (“DLC”), which is commercially available from, e.g. Hoffmann-La Roche Inc. under the trade name Rovimix® E-40%.

“Vitamin E” as used herein broadly embraces a group of related fat soluble compounds that includes α-tocopherol, β-tocopherol, γ-tocopherol, and δ-tocopherol. In addition, each of these four compounds has a “d” form, which is the natural form, and a “d,1” form which is the synthetic form. Preferably, vitamin E is provided in the form of d,1-α-tocopherol and salts thereof such as for example, succinate, acetate, palmitate, and propionate. Mixtures of d,1-α-tocopherol salts may also be used in the present invention. More preferably, d,1-α-tocopherol acetate is used as the “vitamin E” of the present invention.

In the present invention, the fat soluble vitamin must be “stable,” that is, it does not degrade substantially during processing, and is active when ingested by a feed animal. As used herein, a “fat soluble vitamin” is considered stable if its “% Target Value” is above about 50% for at least two weeks. Preferably, a fat soluble vitamin's “% Target Value” is above about 75% for at least about two weeks, such as for example one month.

As used herein, a “fat source” is any lipid-containing material that acts as a solvent for a vitamin and that is non-toxic to a feed animal and to those who will consume the meat of a feed animal that has ingested the fat source. Examples of a “fat source” used in the present invention include naturally occurring or synthetic medium chain fatty acids, long chain fatty acids, long chain mono- and poly-unsaturated fatty acids, salts of long chain fatty acids, and combinations thereof.

As is well known, fats have lower amounts of polyunsaturated and higher amounts of saturated fatty acids compared to oils, which have low amounts of saturated fatty acids and high amounts of unsaturated fatty acids. The present invention includes fat soluble vitamins that dissolve in a fat source and an oil source. Likewise, in the present invention a fat soluble vitamin also dissolves in a fatty acid source, which contains only a part of the fat or oil source. As used herein, a fat soluble vitamin is also soluble in a solvent containing mixtures of fat sources, oil sources, and/or fatty acids.

In the present invention, “medium chain fatty acids” mean C₇ to C₁₅ fatty acids, such as for example, caprylic acid, capric acid, lauric acid, myristic acid, C15:0 fatty acid, and combinations thereof. As used herein, “long chain fatty acids” mean C₁₆ to C₂₄ or higher fatty acids, such as for example, palmitic acid, margaric acid, stearic acid, arachidic acid, lignoceric acid, and combinations thereof. The present invention also includes salts of the long chain fatty acids, i.e., soaps.

In some cases, the fatty acids are unsaturated, i.e., they have at least one double carbon bond in the fatty acid backbone. “Unsaturated fatty acids” as used herein include palmitoleic acid, oleic acid, eicosenic acid, C14:1 fatty acid, C22:1 fatty acid, linoleic acid, unconjugated linolenic acid, arachidonic acid, C16:1 trans, C18:1 trans, cis/trans fatty acids, and combinations thereof.

In the present invention, the fat source may be from a vegetable source, an animal source, and mixtures thereof. For purposes of the present invention, “vegetable source” includes materials extracted, derived or obtainable from plant and vegetable materials. In the present invention, the fat source is produced according to conventional methods for extracting fats from plant, vegetable or animal materials.

The solvent may be obtained from poultry fat (e.g., chicken fat, duck fat, geese fat, and the like), swine fat, sheep fat, tallow, and grease obtained from restaurants. The solvent also may be obtained from plant products, such as for example, cotton seed oil, coconut oil, corn oil, rapeseed oil, soybean oil, sunflower oil, and palm kernel oil refined. In the present invention, the solvent may include combinations of the aforementioned materials.

Preferably, the solvent is poultry fat or restaurant grease. More preferably, the fat source is beef tallow.

As used herein, “beef tallow” or “tallow”, which terms are used interchangeably, is a mixture of tri-glycerides of higher fatty acids derived from cattle. A typical distribution of fatty acids in tallow is as follows: 2% myristic acid (C₁₄-saturated), 32.5% palmitic acid (C₁₆-saturated), 14.5% stearic acid (C₁₈-saturated), 48.3% oleic acid (C₁₈-one double-bond, at C₉), and 2.7% unconjugated linoleic acid (C₁₅-two double-bonds, at C₆ and C₉). The melting range of the fatty acids in beef tallow is typically from about 37° C. to 47° C.

In the present invention, tallow may be obtained by any conventional method, such as for example by heating animal fat and adding water to the fat to impart the desired flow characteristics. Typically, beef tallow may be obtained from the discarded fat generated by animal processing plants also known as rendering plants or slaughter houses. Beef tallow obtained from such plants is an inexpensive source of fat and is readily combinable with conventional feed compositions.

As used herein, “feed composition” means a source of food for a feed animal. The “feed compositions” of the present invention are typically used in commercial feed lots or poultry farms for feeding, e.g., cattle, pigs, goats, sheep, and poultry, including for example, chicken, ducks, geese, ostrich, and the like.

A “feed composition” or “animal feed” according to the invention usually contains 0-80%, preferably 10-70% by weight of cereals; 0-30%, preferably 0-15%, such as 1-8% by weight of feed fat; 0-85%, preferably 10-50% by weight of protein-containing nutritious substances of a type other than cereals; and 0-12%, preferably 1-10% by weight of water soluble vitamins, minerals, enzymes, flavorings, antibiotics, probiotics, and optionally other additives usually included in animal feed. Any conventional animal feed, however, may be used based on the type of feed animal, length of stay at the feed lot, etc.

In the process according to the present invention, the fat soluble vitamin is dissolved in the solvent using any conventional method to form a “vitamin-enriched solvent.” In the present invention, “dissolve,” “dissolved,” “capable of dissolving” and the like mean that the fat soluble vitamin(s) have a solubility of about one part solute per about 1,000 parts or fewer of solvent in the solvent.

The solvent may be heated until it is in a liquid or flowable form. The fat soluble vitamin is then added to the liquid or flowable form of the solvent and the mixture is stirred until substantially all of the fat soluble vitamin is dissolved into the solvent.

In the present invention, the selection of the fat soluble vitamin(s) and the solvent will be based on the melting point of the vitamin and the temperature at which the solvent begins to flow. Ideally, the solvent is selected so that the temperature to which it must be heated to achieve a flowing state is above the melting point of the vitamin.

For example, when vitamin E is used as the fat soluble vitamin, a solvent is selected that begins to flow above the melting point of vitamin E, which is −27.5° C. (d,1-α-tocopherol acetate). Thus, tallow, which begins to flow at about 37° C. is an ideally suited solvent for vitamin E. Accordingly, in a preferred embodiment, vitamin E, such as d,1-α-tocopherol acetate, is dissolved in tallow, such as beef tallow.

The ratio of the fat soluble vitamin:solvent is about 10:90 to about 0.01:99.99. Preferably, the ratio is about 0.01-0.03:99.99-99.97, more preferably about 0.02:99.98.

Once the vitamin-enriched solvent is obtained, it may be combined with an animal feed composition in any convenient manner, such as for example, by mixing or spraying.

This embodiment may be practiced using a silo containing, e.g., about 100 tons of beef tallow that is heated to between about 130°-150° C. When the beef tallow is flowable, a vehicle for conveying and distributing animal feed containing a predetermined amount of animal feed is positioned in close proximity to the silo. A dispenser in fluid communication with the silo is positioned so that the beef tallow may be distributed onto the animal feed carried by the vehicle. The dispenser is outfitted with a feed tube for injecting one or more fat soluble vitamins from a storage vessel into the fluid stream of the tallow as it is dispensed onto the animal feed. The dispenser is also outfitted with means for controlling the flow of the tallow and the vitamins. Such control means may include computer-controlled valves.

The amount of tallow and fat soluble vitamin dispensed onto the feed are controlled by monitoring means, such as for example a cpu or a scale, whereby the appropriate amounts of tallow and fat soluble vitamin are dispensed. The dispensing process may be continuous or stepwise, depending on the equipment used.

The turbulence and velocity of the tallow flowing through the dispenser is sufficient to uniformly distribute the fat soluble vitamin in the tallow.

Another embodiment of the invention is a stable feed premix. The stable feed premix includes a fat soluble vitamin-enriched solvent containing, at a minimum, a fat soluble vitamin (or vitamins) and a solvent, both as previously defined, and an edible carrier. The solvent is capable of dissolving the fat soluble vitamin(s). The premix contains a sufficient amount of the fat soluble vitamin (or vitamins) to deliver to a feed animal about 10 to about 400,000 IU vitamin/day of a vitamin selected from the group consisting of vitamins A, D, and E or about 0.25-1.0 gm/day of vitamin K. Various combinations of vitamins A, D, E, and K, in the concentrations set forth above, are also contemplated.

Additional optional components may be added to the premix or other compositions of the present invention, such as for example, flavorings, minerals, enzymes, antibiotics, preservatives, and probiotics.

As used herein, an “edible carrier” means one or more dry components that may be safely consumed by a feed animal. Edible carriers include, for example, one or more of the following: cereals, such as ground or crushed wheat, oats, barley, maize, and rice; vegetable protein feed based on e.g. rape, soy and sunflower; animal protein feed, such as protein E, blood meal, bone meal and fish meal; molasses; and milk products, such as various milk powders and whey powders. The fat soluble vitamin-enriched solvent, which is flowable, i.e., liquid, optionally after heating, may be added to the edible carrier or mixture of edible carriers. After thorough mixing, a mealy or particulate composition is obtained, depending on the degree of grinding of the ingredients, which forms a solid premix.

The premix may then be combined with an animal feed by mixing, e.g. by dry blending, until a substantially homogeneous mixture is obtained. A person of ordinary skill in the art will appreciate that a variety of other techniques may be used to perform the dry-blending.

Ideally, the premix of the present invention does not exhibit a statistically significant degree of desegregation, i.e., become non-homogeneously admixed, when the premix is permitted to settle. Within the scope of the invention, it is also possible to produce a suspension of the premix. This is especially convenient if the feed is prepared for immediate consumption.

An “IU” (“international unit”) as used herein is a standard unit of measurement of biological activity that is used for fat soluble vitamins, e.g., vitamins A, D, and E (as well as for some hormones, enzymes, and vaccines). One IU represents a different amount for different substances. For purposes of the present invention, the weight equivalents for vitamins A, D, and E are as follows:

| | |
|---|---|
| Vitamin A | 1 mg = 833 IU |
| Vitamin D | 2.5 mcg = 100 IU |
| Vitamin E | 1 mg = 1 IU |

Four different forms of vitamin E (the alcohol and ester forms of synthetic racemic (rac) vitamin E and the alcohol and ester forms of natural (RRR) vitamin E are commercially available, and because of their differences in bioactivities and molecular weights, are assigned different values of specific activity (IU per milligram) according to the National Formulary as follows:

1 mg all-rac-α-tocopherol acetate=1.00 IU

1 mg all-rac-α-tocopherol=1.10 IU

1 mg RRR-α-tocopherol acetate=1.36 IU

1 mg RRR-α-tocopherol=1.49 IU

The IU for any form of a fat soluble vitamin used in accordance with the present invention is calculated by reference to the standards set forth in the International Conference for Unification of Formulae.

Typically, about 500 IU vitamin E/head/day for at least the last 100 days before slaughter are used to achieve a target muscle concentration of 3.25 μg α-tocopherol (AT) per gram of muscle. (Smith et al., 2000. High E Beef The Science and Technology presented at the Canadian Beef Summit (Las Vegas, Nev.). Improvements in beef case life and color stability from such a program are well-documented (Faustman et al., 1989. Improvement of Pigment and Lipid Stability in Holstein Steer Beef by Dietary Supplementation with Vitamin E. J. Food Sci. 54(4):858-862, Arnold et al. 1993. Tissue Equilibration and Subcellular Distribution of Vitamin E Relative to Myoglobin and Lipid Oxidation in Displaced Beef J. Anim. Sci. 71:105-118, Zerby et al. 1999. Effects of muscle α-tocopherol level and surface microbiological contamination on retail case life of fresh beef from the US, Japan and Australia. Meat Science. 52:111-118, Smith et al., supra, and Roeber et al., 2001 J. Anim. Sci. 79:1814-1820.

Preferably, 10 to about 3,000 IU/day of vitamin E are delivered to each animal. When vitamin A is used, it is preferred to deliver about 50,000 to about 200,000 IU/day of the vitamin to each animal.

Calculating how much fat soluble vitamin is required in a feed premix or other formulation according to the present invention to achieve an extended case life (i.e., to prolong a desirable meat color in display counters) requires that the feed animal consume sufficient quantities of the premix or other formulation so that when harvested, the meat contains at least 2 μg vitamin/gm animal product (meat, egg, milk). (See Table 3 below). The feeding regimen used to obtain at least 2 μg vitamin/gm animal product may be varied based on various factors, including the number of days prior to slaughter that the animals are fed the regimen. Thus, in the present invention, “delivers,” “sufficient to deliver,” “delivering,” and the like when used in connection with determining what amount of a fat soluble vitamin to provide to a feed animal to achieve the desired concentration of vitamin in muscle is derived using standard methodology.

For example, Arnold compared several dietary vitamin E regimens and their resultant final tissue concentration of α-tocopherol (AT). Comparing the results to baseline control and assuming AT accretion in longissimus muscle is linear over time, approximate rates of AT accretion are calculated for various E regimens. Because AT rise is likely logarithmic (See e.g., Arnold et al., J. Anim. Sci. 71:105-118. (1993)), these calculated rates are conservative estimates, especially for feeding periods exceeding 150 days.

TABLE 1
Comparison of Dietary Vitamin E Dosage and Resulting
AT Concentrations in Longissimus Muscle

| | | Final Longissimus AT | Calculated Rise in |
|---|---|---|---|
| Vitamin E Dose | | concentration (μg/gm | AT per 50 days |
| (IU/hd/day) | Days Fed | wet muscle) | (μg/gm/50 days) |
| Control | 38-266 | 1.4 | (baseline) |
| 300 | 231-309 | 3.8 | 0.52 |
| 360 | 211-252 | 4.1 | 0.64 |
| 1200 | 38 | 3.5 | 2.76 |
| 1140 | 67 | 6.2 | 3.58 |
| 1280 | 211-252 | 6.8 | 1.28 |
| 2080 | 196-266 | 6.8 | 1.38 |
| 3520 | 196-266 | 7.6 | 1.58 |
| 1000 (McClure) | 25-125 | 9.3 | 2.6 |
| | | (in RCDM muscle) | |

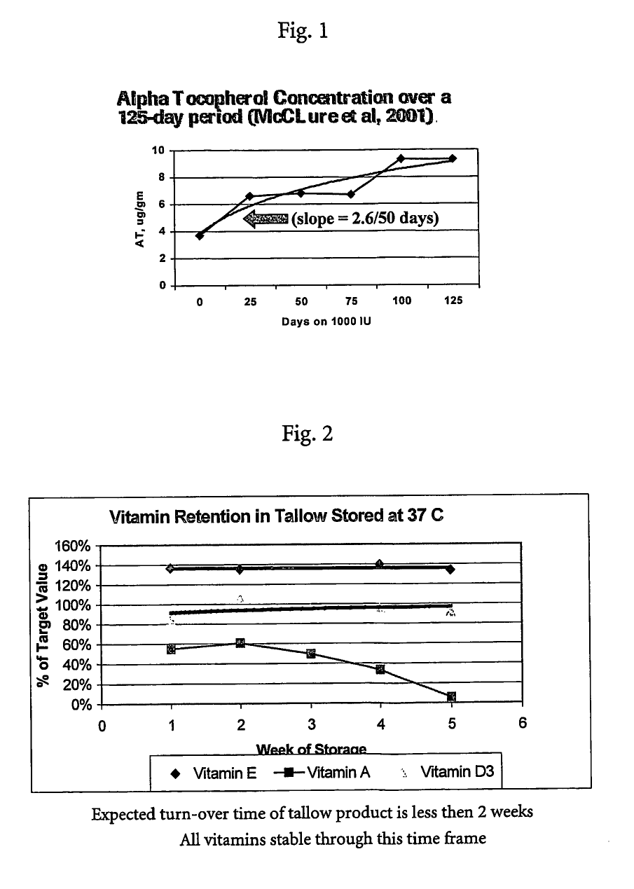

McClure (FIG. 1) tested the rate of accretion in Bos indicus crosses when fed 1,000 IU of Vitamin E/hd/day. Groups of cattle were slaughtered at 25-day intervals, and neck muscles obtained for tissue AT analysis. Because the controls were already receiving 200 IU E/day, initial AT concentrations were above 3.5. However, RCDM (rectus capitis dorsalis major) AT concentration rose in a logarithmic fashion, eventually reaching a plateau of 9.3 μg/gm. (McClure et al., Determination of Appropriate Vitamin E Supplementation Levels and Administration Times to Ensure Adequate Muscle Tissue Alpha-Tocopherol Concentrations in Cattle Destined for the Nolan Ryan Tender-Aged Beef (NRTAAB) Program, Animal Sciences Report (2002)).

Combining the results from Arnold and McClure, and bearing in mind that various muscles accrete AT at different rates (sirloin>inside round>RCDM>strip loin; Roeber et al., Effects of Three Levels of α-Tocopherol Acetate Supplementation to Feedlot Cattle on Performance of Beef Cuts (2001)), average accretion rates for AT in longissimus muscle can be calculated:

TABLE 2
Calculated Accretion Rates for AT at various Dietary Vitamin E Doses

| | AT Accretion |
|---|---|
| Vitamin E Dose (IU/hd/day) | (μg AT/gm wet muscle/50 days) |
| Less than 500 | 0.5-0.6 |
| 500 | 0.75-1.0 |
| 1000+ | 1.5-3.6 |

Thus, to achieve a target level of AT of at least 2 μg/gm animal product (e.g., 3.2 or 4.2 μg/gm muscle) in muscle, the following general feeding regimen may be used:

TABLE 3
Vitamin E Regimens

| Tissue Target | Feeding | Recommended | Total E Fed |
|---|---|---|---|
| (μg AT/gm muscle) | Period (days) | Vitamin E (IU/hd/day) | (IU's) |
| 3.2 | >150 | 400 | 60,000 |
| | 100 | 500 | 50,000 |
| | 50 | 1,000 | 50,000 |
| 4.2 | 100 | 1,000 | 100,000 |

Another embodiment of the invention is a stable, vitamin-enriched solvent for supplementing a feed composition. The vitamin-enriched solvent contains a fat soluble vitamin dissolved in a solvent as set forth above. The fat soluble vitamin is present in the solvent at a concentration sufficient to deliver to a feed animal about 10 to about 400,000 IU vitamin/day of a vitamin selected from the group consisting of vitamins A, D, and E or about 0.25-1.0 gm/day of vitamin K. Various combinations of vitamins A, D, E, and K, in the concentrations set forth above, are also contemplated.

The vitamin-enriched solvent according to this embodiment may take any convenient form. Typically, the vitamin-enriched solvent will be in the form of a liquid, an oil, an emulsion, a dispersion, a disposable liquid concentrate, or a colloidal suspension. Preferably, the vitamin-enriched solvent is in the form of a dispersible liquid concentrate (DLC). The ratio of fat soluble vitamin:solvent is the same as set forth above.

The vitamin-enriched solvent may further include one or more preservatives, such as for example, butylated hydroxy anisole (BHA), butylated hydroxy toluene (BHT), ethoxyquin, and combinations thereof.

To form a DLC according to the present invention, a fat soluble vitamin, such as for example, vitamin E (as d,1-α-tocopherol acetate), is added to post-rendered tallow and heated to about 100° C. with mixing. When the vitamin E is completely dispersed in the tallow, the DLC is formed. In this form, the DLC is very flexible. For example, the DLC may be stored in a tank until ready for use or distribution. The DLC may be applied to an animal feed by, e.g., spraying it onto feed in delivery vehicles just prior to delivery to animals at a feed lot. Alternatively, the DLC may be added onto the feed as it is being dispensed from a delivery vehicle at the feed yard.

In this embodiment, “supplementing a feed composition” means that the vitamin-enriched solvent is distributed on to the surface of the feed composition. Thus, the vitamin-enriched solvent may be mixed into, sprayed onto or layered over the feed composition after processing of the feed composition, e.g. at the feed lot.

Another embodiment of the invention is a stable, vitamin-enriched feed. In this embodiment, the stable, vitamin-enriched feed includes an animal feed composition and a vitamin-enriched solvent containing a fat soluble vitamin dissolved in a solvent at a concentration sufficient to deliver to a feed animal about 10 to about 400,000 IU vitamin/day of a vitamin selected from the group consisting of vitamins A, D, and E or about 0.25-1.0 gm/day of vitamin K. Various combinations of vitamins A, D, E, and K, in the concentrations set forth above, are also contemplated. The animal feed composition, vitamin-enriched solvent, fat soluble vitamin, and solvent of this embodiment are defined above.

Another embodiment of the invention is a process for supplementing the diet of a feed animal with a fat soluble vitamin. This process includes contacting an animal feed with a vitamin-enriched solvent containing a fat soluble vitamin dissolved in a solvent at a concentration sufficient to deliver to a feed animal about 10 to about 400,000 IU vitamin/day of a vitamin selected from the group consisting of vitamins A, D, and E or about 0.25-1.0 gm/day of vitamin K. Various combinations of vitamins A, D, E, and K, in the concentrations set forth above, are also contemplated. The animal feed, vitamin-enriched solvent, fat soluble vitamin, and solvent of this embodiment are defined above.

A further embodiment of the invention is a process for extending the shelf life of an animal product. This process includes contacting an animal feed with a stable, vitamin-enriched solvent containing a fat soluble vitamin dissolved in a solvent at a concentration sufficient to deliver to a feed animal about 10 to about 400,000 IU vitamin/day of a vitamin selected from the group consisting of vitamins A, D, and E or about 0.25-1.0 gm/day of vitamin K. Various combinations of vitamins A, D, E, and K, in the concentrations set forth above, are also contemplated. The enriched feed is then provided to a feed animal for a sufficient period of time to yield at least 2 μg vitamin/gm animal product, preferably at least 3.25 μg vitamin/gm animal product, when harvested.

As used herein, the phrase “animal product” means meat, milk, and eggs. Preferably, the animal product is meat.

The animal feed, vitamin-enriched solvent, fat soluble vitamin, and solvent of this embodiment are defined above. Determining how much of the enriched feed to supply to each animal per day and for how many days to maintain the feed animals on this regime is determined using the parameters set forth above.

Another embodiment is a process for making a stable, vitamin-enriched supplement for a feed composition. This process includes incorporating a sufficient quantity of a fat soluble vitamin into a solvent, as set forth above, to produce a vitamin-enriched supplement that delivers between about 10 to about 400,000 IU vitamin/day of a vitamin selected from the group consisting of vitamins A, D, and E or about 0.25-1.0 gm/day of vitamin K. Various combinations of vitamins A, D, E, and K, in the concentrations set forth above, are also contemplated. In this embodiment, the fat soluble vitamin is evenly distributed throughout the fat source.

In this process, “incorporating” means any conventional method for combining a liquid and a solid or a liquid and a liquid, including for example, mixing, spraying, and the like. Typically, the fat soluble vitamin is heated to a flowable state and then mixed with the solvent, which may also be heated to facilitate the mixing.

As used herein, “a sufficient quantity” means that amount of a fat soluble vitamin that must be incorporated into a solvent so as to deliver between about 10 to about 400,000 IU vitamin/day/head of vitamins A, D, and E or about 0.25-1.0 gm/day/head of vitamin K. Such amounts are readily calculated by multiplying the number of animals fed per day by the target number of IU (or gms) of the vitamin desired to be delivered to each animal as described above.

The vitamin-enriched supplement may be delivered to the feed animals independent of the animal feed or it may be incorporated into an animal feed. Again, to incorporate the vitamin-enriched supplement into an animal feed one may use any conventional means of combining a liquid or flowable material with a solid or liquid, such as for example, mechanical mixing, spraying, layering, etc.

The following examples are provided to further illustrate the process of the present invention. These examples are illustrative only and are not intended to limit the scope of the invention in any way.

### EXAMPLES

### Example 1

### Fat Soluble Vitamins are Stable Over Typical Shelf-Lives

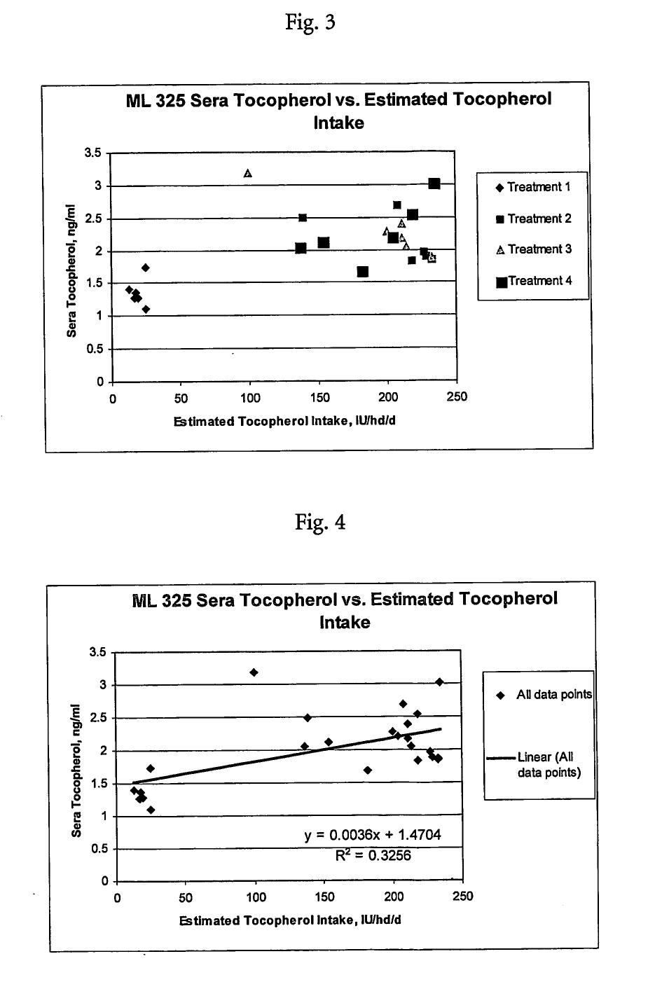

Vitamin enriched tallow compositions were prepared according to the present invention with vitamins E, A and D₃, respectively. The compositions were stored at 37° C. for six weeks. At one week intervals a sample from each composition was removed and assayed for the amount of vitamin present. Using these values, % of Target Values were calculated. The data are shown in FIG. 2, which demonstrate that all tested vitamins are stable in tallow, for at least two weeks, which is greater than the expected turnover time of tallow products used in commercial feed lots.

### Example 2

### Preparation of Vitamin Premixes

Three preparations of vitamin premixes (Treatments C, D, and E) were prepared as follows:

Treatment C

981 g of fine ground corn (Montfort, Greeley, Colo.), 12.5 g of a vitamin A/D mixture (dry beadlet form) and 6.25 g of vitamin E (d,1-α-tocopherol)(50% adsorbate) were combined in a V-mixer for 10 minutes. The concentration of vitamins in the final product were as follows:

vitamin A: 156,251 IU/kg;

vitamin D: 15,625 IU/kg; and

vitamin E: 1,565 IU/kg.

Treatment D

850 g of fine ground corn (Montfort, Greeley, Colo.) was placed in a V-mixer and mixed for 2 minutes. 1.5 g of a mixture of vitamins A and D in DLC form was dissolved in a small amount of beef tallow (Conagra). 39.1 g of vitamin E in DLC form was separately dissolved in a small amount of beef tallow. A small amount of fine ground corn was carefully mixed into each preparation of tallow-vitamins A/D and tallow-vitamin E. An additional amount of fine ground corn was manually mixed into each tallow-vitamin A/D and tallow-vitamin E preparations. Each of the vitamin-tallow preparations was added to the remaining tallow (9.4 g total) and additional fine ground corn was added to bring the final amount of fine ground corn to in the tallow to 100 g. The tallow-vitamin-ground corn mixture was added to the V-mixer containing the 850 g of corn and mixed for 5 minutes. The mixer was then stopped and any tallow adhering to the sides was removed and the contents mixed for an additional 3 minutes.

The concentration of vitamins in the final product were as follows:

Vitamin A: 375,002 IU/kg;

Vitamin D: 37,500 IU/kg; and

Vitamin E: 15,624 IU/kg.

Treatment E

844 g of fine ground corn (Montfort, Greeley, Colo.) was placed in a V-mixer and mixed for 2 minutes. 16.95 g of vitamin E oil was mixed with a small amount of beef tallow (Conagra). This mixture was then combined with a larger amount of beef tallow to bring the total amount of beef tallow to 33 g. 6.25 g of a mixture of vitamins A and D in beadlet form was combined with a small amount of fine ground corn. This mixture was added to the vitamin E-tallow preparation. An additional amount of fine ground corn was manually mixed into the tallow-vitamin preparation until 100 g of fine ground corn was mixed in. The vitamin-tallow-corn preparation was added to the V-mixer containing the 844 g of corn and mixed for 5 minutes. The mixer was then stopped and any tallow adhering to the sides was removed and the contents mixed for an additional 3 minutes.

The concentration of vitamins in the final product were as follows:

Vitamin A: 156,251 IU/kg;

Vitamin D: 15,625 IU/kg; and

Vitamin E: 15,628 IU/kg.

### Example 3

### Delivering Fat Soluble Vitamins in a Fat Source

Seven weaned lambs (three ewes and four wethers) of approximately ten months of age were randomly assigned to pens and fed a feedlot-type diet of ground alfalfa, flaked corn, cottonseed meal, limestone, tallow and one of four vitamin premixes (basal, C, D, or E prepared according to Example 2) twice daily. Corn comprised 82% of the ration during the final adaptation and experimental periods.

The “Trt 1, basal” vitamin premix contained vitamin A (dry beadlet form) at 156251 IU/kg, vitamin D (dry beadlet form) at 15625 IU/kg and vitamin E (50% adsorbate form) at 1565 IU/kg. The components of each premix were then mixed in a feed mixer for about 2-4 minutes. Premixes 2 through 4 contained a total of 50 g of lipid/kg premix from animal tallow alone as in treatment 2 or a combination of animal tallow, DLC or E oil. The “Trt 2, C” premix contained vitamin A (dry beadlet form) at 375000 IU/kg, vitamin D (dry beadlet form) at 37500 IU/kg and vitamin E (50% adsorbate form) at 15625 IU/kg. The “Trt 3, D” premix contained vitamin A (DLC form) at 375000 IU/kg, vitamin D (DLC form) at 37500 IU/kg and vitamin E (DLC form) at 15625 IU/kg. The “Trt 4, E” premix contained vitamins A (dry beadlet form) at 375000 IU/kg, vitamin D (dry beadlet form) at 37500 IU/kg and vitamin E (pure oil form) at 15625 IU/kg.

Each sheep received 8 gm of a single vitamin premix twice daily during feeding. Therefore, the basal premix was fed to supply vitamin A at 2500 IU/hd/d, vitamin D at 250 IU/hd/d and vitamin E at 25 IU/hd/d, while the “C, D and E” premixes were fed to supply vitamin A at 6000 IU/hd/d, vitamin D at 600 IU/hd/d and vitamin E at 250 IU/hd/d. A sample aliquot of each vitamin premix, total mixed ration and tallow were taken and stored frozen for later analysis.

Six lambs were chosen to participate in the experimental vitamin premix phase based on feed intake and behavior. Sheep #1 was excluded from the experiment, but continued being fed and bled along with the others. After at least three full days of feeding each of the vitamin premixes, the lambs were bled and sera frozen until analyzed for vitamins A (retinol), E (α-tocopherol) and D₃.

TABLE 4
Retinol and tocopherol sera concentrations by vitamin premix treatment.

| | Retinol, ng/ml | | | | Tocopherol, ng/ml | | | |
|---|---|---|---|---|---|---|---|---|
| Sheep # | Basal | C | D | E | Basal | C | D | E |
| 2 | 252 | 262 | 419 | 216 | 1.27 | 2.49 | 3.19 | 1.68 |
| 3 | 314 | 273 | 323 | 360 | 1.36 | 1.96 | 2.39 | 2.05 |
| 4 | 362 | 245 | 235 | 409 | 1.74 | 1.85 | 1.87 | 3.01 |
| 5 | 233 | 254 | 279 | 340 | 1.1 | 1.83 | 2.27 | 2.54 |
| 6 | 280 | 307 | 352 | 200 | 1.4 | 2.68 | 2.17 | 2.2 |
| 7 | 287 | 391 | 306 | 354 | 1.28 | 1.89 | 2.05 | 2.12 |
| Avg | 288 | 289 | 319 | 313 | 1.36 | 2.12 | 2.32 | 2.27 |
| SD | 45.9 | 54.5 | 63.1 | 84.9 | 0.21 | 0.37 | 0.46 | 0.46 |

There were some differences in feed intake between lambs during the experiment (Table 5).

TABLE 5
Average daily feed intake in kg by sheep, treatment and period.

| | | Period | | Period | | | | |
|---|---|---|---|---|---|---|---|---|
| Sheep | Trt | 1^{a} | Trt | 2^{b} | Trt | Period 3^{c} | Trt | Period 4^{d} |
| 2 | Basal | 0.6 | C | 0.5 | D | 0.4 | E | 0.8 |
| 3 | Basal | 0.7 | C | 1.0 | D | 1.1 | E | 0.6 |
| 4 | Basal | 1.2 | D | 1.4 | E | 1.5 | C | 1.4 |
| 5 | Basal | 1.2 | D | 1.2 | E | 1.4 | C | 1.4 |
| 6 | Basal | 0.5 | E | 0.9 | C | 1.0 | D | 1.1 |
| 7 | Basal | 0.7 | E | 0.8 | C | 1.1 | D | 1.2 |

^{a}Period 1 feed intake measured 12/2-Dec. 9, 2001.
^{b}Period 2 feed intake measured 12/10-Dec. 12, 2001.
^{c}Period 3 feed intake measured 12/13-Dec. 15, 2001.
^{d}Period 4 feed intake measured 12/16-Dec. 18, 2001.

Five of the six lambs gained weight during the experiment (Table 6)

TABLE 6
Sheep body weight, kg

| | | Weight, kg | Weight, kg |
|---|---|---|---|
| Sheep # | Sex | Dec. 3, 2001 | Dec. 19, 2001 |
| 2 | Ewe | 36.3 | 36.3 |
| 3 | Wether | 37.2 | 39 |
| 4 | Wether | 37.2 | 39.5 |
| 5 | Ewe | 39.5 | 41.7 |
| 6 | Wether | 39 | 40.8 |
| 7 | Wether | 41.7 | 42.6 |

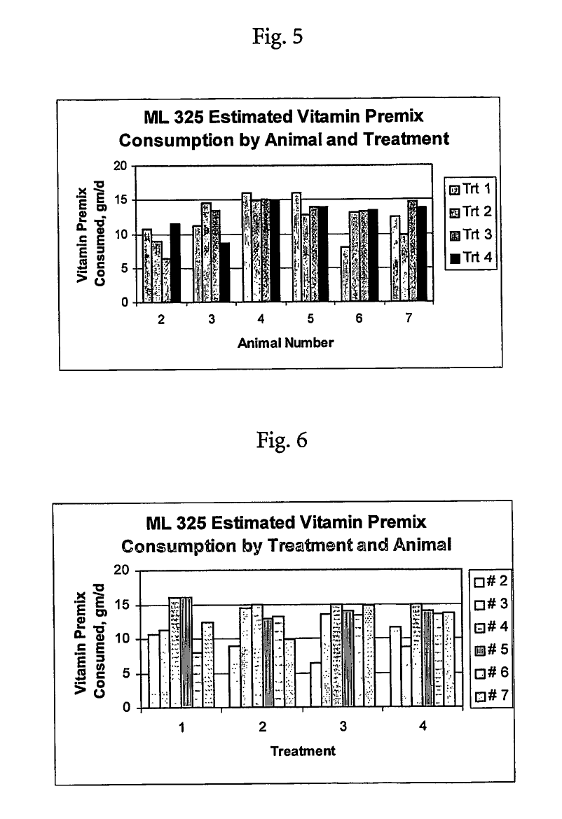

Statistical analyses were performed using SAS (Cary, N.C.), The estimated amount of vitamin consumption (p19, VitCons) did not differ (P>0.6) by treatment or by period. Nevertheless, due to differences in feed refusal within treatments during the experiment, it was decided to estimate daily vitamin premix intake according to the fraction of the offered feed that was consumed. For example, a lamb consuming 85% of feed offered during period 2 is assumed to consume 85% of the vitamin premix offered or 13.6 g of vitamin premix per day. This estimate of vitamin supplement consumption was then used as a covariate for statistical analyses. In addition to examining the treatment effects on blood vitamin concentrations a differential from baseline was calculated. The baseline vitamin A and E sera concentrations (period 1) were subtracted from the vitamin A and E concentrations during periods 2 through 4. The raw data during period 1 (baseline) and raw data for periods 2 through 4 were tested for normality using SAS. The data from these experiments are set forth in FIGS. 3, 4, 5 and 6.

Results in Brief:

The similarity of the rise in serum tocopherol levels over basal indicated that treatments C (E as 50% adsorbate) and E (E-oil in tallow) were equivalent as vitamin E sources when analyzed with or without vitamin consumption as a covariate (P>0.10). Retinol and tocopherol levels were highest for sheep fed the Trt 3-D, DLC supplement (P <0.05) when analyzed with or without vitamin consumption as a covariate. There were no period effects when the vitamin consumption was used as a covariate.

The invention being thus described, it will be obvious that the same may be varied in many ways. Such variations are not to be regarded as a departure from the spirit and scope of the invention and all such modifications are intended to be included within the scope of the following claims.

1. A process for delivering a stable, fat soluble vitamin to a feed composition comprising:
a) dissolving a fat soluble vitamin in a solvent selected from the group consisting of a fat source, an oil source, a fatty acid source and combinations thereof to form a vitamin-enriched solvent; and
b) combining the vitamin-enriched solvent with a feed composition.

2. A process according to claim 1 wherein the solvent is selected from the group consisting of medium chain fatty acids, long chain saturated fatty acids, long chain mono- and poly-unsaturated fatty acids, salts of log chain fatty acids, and combinations thereof.

3. A process according to claim 2 wherein the medium chain fatty acids are selected from the group consisting of caprylic acid, capric acid, lauric acid, myristic acid, C15:0 fatty acid, and combinations thereof.

4. A process according to claim 2 wherein the long chain fatty acids are selected from the group consisting of palmitic acid, margaric acid, stearic acid, arachidic acid, lignoceric acid, and combinations thereof.

5. A process according to claim 2 wherein the unsaturated fatty acids are selected from the group consisting of palmitoleic acid, oleic acid, eicosenic acid, C14:1 fatty acid, C22:1 fatty acid, linoleic acid, unconjugated linolenic acid, arachidonic acid, C16:1 trans, C18:1 trans, cis/trans fatty acids, and combinations thereof.

6. A process according to claim 1 wherein the solvent is selected from the group consisting of a fat from a non-animal source, a fat from an animal source, and combinations thereof.

7. A process according to claim 6 wherein the solvent is selected from the group consisting of poultry fat, swine fat, sheep fat, tallow, restaurant grease, cotton seed oil, coconut oil, corn oil, rapeseed oil, soybean oil, sunflower oil, palm kernel oil refined, and combinations thereof.

8. A process according to claim 7 wherein the solvent is poultry fat.

9. A process according to claim 7 wherein the solvent is tallow.

10. A process according to claim 7 wherein the solvent is restaurant grease.

11. A process according to claim 1 wherein the fat soluble vitamin is selected from the group consisting of vitamin A, vitamin D, vitamin E, vitamin K, precursors and metabolites of vitamins A, D, E, and K, salts of vitamins A, D, E, and K, and combinations thereof.

12. A process according to claim 11 wherein the fat soluble vitamin is vitamin E and salts thereof.

13. A process according to claim 12 wherein the vitamin E is selected from the group consisting of d,1-α-tocopherol succinate, d,1-α-tocopherol acetate, d,1-α-tocopherol palmitate, d,1-α-tocopherol propionate, and mixtures thereof.

14. A process according to claim 13 wherein the vitamin E is d,1-α-tocopherol acetate.

15. A process according to claim 1 wherein the fat soluble vitamin is d,1-α-tocopherol acetate and the solvent is beef tallow.

16. A process according to claim 1 wherein the fat soluble vitamin is in a form selected from the group consisting of powders, flakes, liquids, oils, dispersions, and emulsions.

17. A process according to claim 16 wherein the fat soluble vitamin is an oil.

18. A process according to claim 1 wherein the fat soluble vitamin is in the form of a dispersible liquid concentrate.

19. A process according to claim 1 wherein the ratio of fat soluble vitamin:solvent is about 10:90 to about 0.01:99.99.

20. A process according to claim 19 wherein the ratio is about 0.01-0.03:99.99-99.97.

21. A process according to claim 20 wherein the ratio is about 0.02:99.98.

22. A stable feed premix comprising:
a) a fat soluble vitamin;
b) a solvent selected from the group consisting of a fat source, an oil source, a fatty acid source and combinations thereof, which solvent is capable of dissolving the fat soluble vitamin and delivering to a feed animal about 10 to about 400,000 IU vitamin/day of a vitamin selected from the group consisting of vitamins A, D, and E, about 0.25-1.0 gm/day of vitamin K or mixtures of vitamins A, D, E, and K in the amounts provided; and
c) an edible carrier.

23. A premix according to claim 22 wherein vitamin E in an amount sufficient to deliver to a feed animal about 10-3,000 IU/day is dissolved in the solvent.

24. A premix according to claim 22 wherein vitamin A in an amount sufficient to deliver to a feed animal about 50,000-200,000 IU/day is dissolved in the solvent.

25. A premix according to claim 22 wherein the solvent is selected from the group consisting of medium chain fatty acids, long chain saturated fatty acids, long chain mono- and poly unsaturated fatty acids, salts of long chain fatty acids, and combinations thereof.

26. A premix according to claim 25 wherein the medium chain fatty acids are selected from the group consisting of caprylic acid, capric acid, lauric acid, myristic acid, C15:0 fatty acid, and combinations thereof.

27. A premix according to claim 25 wherein the long chain fatty acids are selected from the group consisting of palmitic acid, margaric acid, stearic acid, arachidic, lignoceric, and combinations thereof.

28. A premix according to claim 25 wherein the long chain unsaturated fatty acids are selected from the group consisting of palmitoleic acid, oleic acid, eicosenic acid, C1 4:1 fatty acid, C22:1 fatty acid, linoleic acid, linolenic acid, arachidonic acid, C16:1 trans, C18:1 trans, cis/trans fatty acids, and combinations thereof.

29. A premix according to claim 22 wherein the solvent is selected from the group consisting of a fat from a non-animal source, a fat from an animal source, and combinations thereof.

30. A premix according to claim 29 wherein the solvent is selected from the group consisting of poultry fat, swine fat, sheep fat, beef tallow, restaurant grease, cotton seed oil, coconut oil, corn oil, rapeseed oil, soybean oil, sunflower oil, palm kernel oil refined, and combinations thereof.

31. A premix according to claim 30 wherein the solvent is poultry fat.

32. A premix according to claim 30 wherein the solvent is tallow.

33. A premix according to claim 31 wherein the solvent is restaurant grease.

34. A premix according to claim 22 wherein the fat soluble vitamin is vitamin B and salts thereof.

35. A premix according to claim 34 wherein the vitamin E is selected from the group consisting of d,1-α-tocopherol succinate, d,1-α-tocopherol acetate, d,1-α-tocopherol palmitate, d,1-α-tocopherol propionate, and mixtures thereof.

36. A premix according to claim 35 wherein the vitamin E is d,1-α-tocopherol acetate.

37. A premix according to claim 22 wherein the fat soluble vitamin is d,1-α-tocopherol acetate and the solvent is beef tallow.

38. A premix according to claim 22 wherein the fat soluble vitamin is in a form selected from the group consisting of powders, oils, dispersions, and emulsions.

39. A premix according to claim 38 wherein the fat soluble vitamin is an oil.

40. A premix according to claim 22 wherein the fat soluble vitamin is in the form of a dispersible liquid concentrate.

41. A premix according to claim 22 wherein the ratio of fat soluble vitamin:solvent is about 10:90 to about 0.01:99.99.

42. A premix according to claim 41 wherein the ratio is about 0.01-0.03:99.99-99.97.

43. A premix according to claim 42 wherein the ratio is about 0.02:99.98.

44. A stable, vitamin-enriched solvent for supplementing a feed composition, the vitamin-enriched solvent comprising:
a fat soluble vitamin dissolved in a solvent selected from the group consisting of a fat source, an oil source, a fatty acid source and combinations thereof, which fat soluble vitamin is present in the solvent at a concentration sufficient to deliver to a feed animal about 10 to about 400,000 IU vitamin/day of a vitamin selected from the group consisting of vitamins A, D, and E, about 0.25-1.0 gm/day of vitamin K or mixtures of vitamins A, D, E, and K in the amounts provided.

45. A vitamin-enriched solvent according to claim 44 wherein the solvent is selected from the group consisting of a fat from a non-animal source, a fat from an animal source and combinations thereof.

46. A vitamin-enriched solvent according to claim 45 wherein the solvent is selected from the group consisting of poultry fat, swine fat, sheep fat, beef tallow, restaurant grease, cotton seed oil, coconut oil, corn oil, rapeseed oil, soybean oil, sunflower oil, palm kernel oil refined, and combinations thereof.

47. A vitamin-enriched solvent according to claim 46 wherein the solvent is tallow.

48. A vitamin-enriched solvent according to claim 44 wherein the fat soluble vitamin is vitamin E and salts thereof.

49. A vitamin-enriched solvent according to claim 48 wherein the vitamin E is selected from the group consisting of d,1-α-tocopherol succinate, d,1-α-tocopherol acetate, d,1-α-tocopherol palmitate, d,1-α-tocopherol propionate, and mixtures thereof.

50. A vitamin-enriched solvent according to claim 49 wherein the vitamin E is d,1-α-tocopherol acetate.

51. A vitamin-enriched solvent according to claim 44 wherein the fat soluble vitamin is d,1-α-tocopherol acetate and the fat source is beef tallow.

52. A vitamin-enriched solvent according to claim 44 wherein the ratio of fat soluble vitamin:solvent is about 10:90 to about 0.01:99.99.

53. A vitamin-enriched solvent according to claim 52 wherein the ratio is about 0.02:99.98.

54. A vitamin-enriched solvent according to claim 44 further comprising a preservative selected from the group consisting of butylated hydroxy anisole (BHA), butylated hydroxy toluene (BHT), ethoxyquin, and combinations thereof.

55. A stable, vitamin-enriched feed comprising:
a) an animal feed composition; and
b) a vitamin-enriched solvent comprising a fat soluble vitamin dissolved in a fat source, an oil source, a fatty acid source and combinations thereof, the fat soluble vitamin being present in the solvent at a concentration sufficient to deliver to a feed animal about 10 to about 400,000 IU vitamin/day of a vitamin selected from the group consisting of vitamins A, D, and E, about 0.25-1.0 gm/day of vitamin K or mixtures of vitamins A, D, E, and K in the amounts provided.

56. A vitamin-enriched feed according to claim 55 wherein the solvent is selected from the group consisting of a fat from a non-animal source, a fat from an animal source, and combinations thereof.

57. A vitamin-enriched feed according to claim 56 wherein the solvent is selected from the group consisting of poultry fat, swine fat, sheep fat, beef tallow, restaurant grease, cotton seed oil, coconut oil, corn oil, rapeseed oil, soybean oil, sunflower oil, palm kernel oil refined, and combinations thereof.

58. A vitamin-enriched feed according to claim 57 wherein the solvent is beef tallow.

59. A vitamin-enriched feed according to claim 55 wherein the fat soluble vitamin is vitamin E and salts thereof.

60. A vitamin-enriched feed according to claim 59 wherein the vitamin E is selected from the group consisting of d,1-α-tocopherol succinate, d,1-α-tocopherol acetate, d,1-α-tocopherol palmitate, d,1-α-tocopherol propionate, and mixtures thereof.

61. A vitamin-enriched feed according to claim 60 wherein the vitamin E is d,1-α-tocopherol acetate.

62. A vitamin-enriched feed according to claim 55 wherein the fat soluble vitamin is d,1-α-tocopherol acetate and the solvent is beef tallow.

63. A vitamin-enriched feed according to claim 55 wherein the ratio of fat soluble vitamin:solvent is about 10:90 to about 0.01:99.99.

64. A vitamin-enriched feed according to claim 63 wherein the ratio is about 0.02:99.98.

65. A process for supplementing the diet of a feed animal with a fat soluble vitamin comprising:
contacting an animal feed with a vitamin-enriched solvent comprising a fat soluble vitamin dissolved in a solvent selected from the group consisting of a fat source, an oil source, a fatty acid source and combinations thereof at a concentration sufficient to deliver to a feed animal about 10 to about 400,000 IU vitamin/day of a vitamin selected from the group consisting of vitamins A, D, and E, about 0.25-1.0 gm/day of vitamin K or mixtures of vitamins A, D, E, and K in the amounts provided.

66. A process according to claim 65 wherein the solvent is selected from the group consisting of a fat from a non-animal source, a fat from an animal source, and combinations thereof.

67. A process according to claim 66 wherein the solvent is selected from the group consisting of poultry fat, swine fat, sheep fat, beef tallow, restaurant grease, cotton seed oil, coconut oil, corn oil, rapeseed oil, soybean oil, sunflower oil, palm kernel oil refined, and combinations thereof.

68. A process according to claim 67 wherein the solvent is beef tallow.

69. A process according to claim 65 wherein the fat soluble vitamin is vitamin E and salts thereof.

70. A process according to claim 69 wherein the vitamin E is selected from the group consisting of d,1-α-tocopherol succinate, d,1-α-tocopherol acetate, d,1-α-tocopherol palmitate, d,1-α-tocopherol propionate, and mixtures thereof.

71. A process according to claim 70 wherein the vitamin E is d,1-α-tocopherol acetate.

72. A process according to claim 65 wherein the fat soluble vitamin is d,1-α-tocopherol acetate and the solvent is beef tallow.

73. A process according to claim 65 wherein the ratio of fat soluble vitamin:solvent is about 10:90 to about 0.01:99.99.

74. A process according to claim 73 wherein the ratio is about 0.02:99.98.

75. A process for extending the shelf life of an animal product comprising:
a) contacting an animal feed with a stable, vitamin-enriched solvent comprising a fat soluble vitamin dissolved in a solvent selected from the group consisting of a fat source, an oil source, a fatty acid source and combinations thereof, the fat soluble vitamin being present in the solvent at a concentration sufficient to deliver to a feed animal about 10 to about 400,000 IU vitamin/day of a vitamin selected from the group consisting of vitamins A, D, and E, about 0.25-1.0 gm/day of vitamin K or mixtures of vitamins A, D, E, and K in the amounts provided, to provide an enriched feed; and
b) providing the enriched feed to a feed animal for a sufficient period of time to yield at least 2 μg vitamin/gm animal product when harvested.

76. A process according to claim 75 wherein the enriched feed is provided to the feed animal for a sufficient time to yield at least 3.25 μg vitamin/gm animal product.

77. A process according to claim 75 wherein the animal product is selected from the group consisting of milk, meat, and eggs.

78. A process according to claim 77 wherein the animal product is meat.

79. A process for making a stable, vitamin-enriched supplement for a feed composition comprising:
incorporating a sufficient quantity of a fat soluble vitamin into a solvent selected from the group consisting of a fat source, an oil source, a fatty acid source and combinations thereof to produce a vitamin-enriched supplement that delivers to a feed animal between about 10 to about 400,000 IU vitamin/day of a vitamin selected from the group consisting of vitamins A, D, and E, about 0.25-1.0 gm/day of vitamin K or mixtures of vitamins A, D, E, and K in the amounts provided, the fat soluble vitamin being evenly distributed throughout the solvent.

80. A process according to claim 79 wherein the incorporating step comprises heating the fat soluble vitamin to a flowable state and mixing the fat soluble vitamin with the solvent.

81. A process according to claim 79 wherein the solvent is selected from the group consisting of a fat from a non-animal source, a fat from an animal source, and combinations thereof.

82. A process according to claim 81 wherein the solvent is selected from the group consisting of poultry fat, swine fat, sheep fat, beef tallow, restaurant grease, cotton seed oil, coconut oil, corn oil, rapeseed oil, soybean oil, sunflower oil, palm kernel oil refined, and combinations thereof.

83. A process according to claim 82 wherein the solvent is beef tallow.

84. A process according to claim 79 wherein the fat soluble vitamin is vitamin E and salts thereof.

85. A process according to claim 84 wherein the vitamin E is selected from the group consisting of d,1-α-tocopherol succinate, d,1-α-tocopherol acetate, d,1-α-tocopherol palmitate, d,1-α-tocopherol propionate, and mixtures thereof.

86. A process according to claim 85 wherein the vitamin E is d,1-α-tocopherol acetate.

87. A process according to claim 79 wherein the fat soluble vitamin is d,1-α-tocopherol acetate and the solvent is beef tallow.

88. A process according to claim 79 wherein the fat soluble vitamin is in a form selected from the group consisting of powders, oils, dispersions, and emulsions.

89. A process according to claim 88 wherein the fat soluble vitamin is an oil.

90. A process according to claim 79 wherein the ratio of fat soluble vitamin:solvent is about 10:90 to about 0.01:99.99.

91. A process according to claim 90 wherein the ratio is about 0.02:99.98.

92. A process according to 79 further comprising incorporating the vitamin-enriched supplement into an animal feed.

93. A process according to 92 wherein the animal feed is a liquid feed.

94. A process according to 92 wherein the animal feed is a dry feed.
